(19) United States
(12) Patent Application Publication
(10) Pub. No.: US 2008/0176113 A1
(43) Pub. Date: Jul. 24, 2008

(54) Systems and method for solid oxide fuel cell cathode processing and testing

(76) Inventors: Jian Wu, Schenectady, NY (US); Simon William Gaunt, Guilderland, NY (US); James Anthony Ruud, Delmar, NY (US); Stephane Renou, Clifton Park, NY (US); Todd Michael Striker, Guilderland, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/656,078

(22) Filed: Jan. 22, 2007

(51) Int. Cl. H01M 8/10; B32B 37/00

(52) U.S. Cl. 429/13; 156/277; 156/60; 429/30

(57) ABSTRACT

Systems and methods for high performing in-situ SOFC cathodes, demonstrating self-improved performance over time. Exemplary embodiments include a SOFC including an electrolyte layer, an anode coupled to the electrolyte layer and a cathode coupled to the electrolyte layer, wherein the anode is prepared by applying an anode contact layer to the anode layer and applying anode bond paste to the anode contact layer, wherein the cathode is prepared by screen printing a cathode layer on the electrolyte with or without a barrier layer, and applying cathode bond paste to the dried cathode layer and drying the cathode bond paste in an oven.

### BACKGROUND

The present disclosure generally relates to power generation equipment such as solid oxide fuel cells (SOFCs), and more particularly to systems and methods for high performance and long-term stability of in-situ SOFC cathodes.

A fuel cell is an energy conversion device that produces electricity, by electrochemically combining a fuel and an oxidant across an ionic conducting layer. For example, a solid oxide fuel cell bundle is typically constructed of an array of axially elongated tubular shaped connected fuel cells and associated fuel and air distribution equipment. Alternative constructions to the tubular fuel cells are planar fuel cells constructed from flat single members. The planar fuel cells can be of counter-flow, cross-flow and parallel flow varieties. The members of a typical planar fuel cell comprise tri-layer anode/electrolyte/cathode components that conduct current from cell to cell and provide channels for gas flow into a cubic structure or stack.

Mixed electronic/ionic conducting lanthanum strontium cobalt iron oxide (LSCF) and gadolinium doped ceria (GDC) composite materials have received attention in recent years as a cathode for medium to high temperature (500-800° C.) SOFCs. LSCF/GDC composite cathodes on yttria-stabilized zirconia (YSZ) electrolyte have shown area-specific-resistance (ASR) as low as 0.01 W cm² at 750° C. Typical SOFC processing uses a separate cathode sintering step to achieve desired microstructure of the electrode; and, in some cases, separate cathode and anode bonding steps at high temperatures are used to reduce contact resistance. The sintering temperature for the LSCF/GDC cathode is typically higher than 1000° C. to obtain optimized microstructures. For cell testing, the electrode bonding temperatures can be 900° C. or higher, in order to obtain desired bonding between different components. The high processing temperatures can lead to fatal problems with the use of metal supported SOFCs due to materials reactions such as chromia scale growth and cathode poisoning. Performance degradation rates in a metal supported SOFC can be severe at high processing temperatures. However, the use of a metal substrate for SOFC is critical for the cost reduction of a SOFC system. Therefore the reduction of cell fabrication temperature and simplification of the cell processing steps would be crucial to building an economically feasible SOFC system with better long-term stability.

Sintered substrates and noble metal current collectors are typically used with high processing temperatures. Approaches for the mitigation of degradation often include materials modifications to reduce the rate of degradation from the known degradation mechanisms. Alloy compositions have been developed with lower chromia scale growth rates and chromia volatilization. Another approach to stabilize the performance of fuel cells over time is to incorporate a material that improves its performance with time to offset the degradation behavior. Pt nanocatalysts have been used in the past to improve cell performance with long operation time.

Therefore, there is an economic advantage for systems and methods providing lower cathode processing temperatures and lower cell fabrication temperatures without compromising performance and to have more stable performance over the operation life of the fuel cell.

### BRIEF DESCRIPTION

Disclosed herein is a SOFC fabrication and testing method for a SOFC cell, including preparing the cathode, preparing anode contacts, preparing cathode contacts in-situ, and, attaching cathode and anode current collectors.

Further disclosed herein is a SOFC, including an anode-supported electrolyte layer, an anode contact layer screen printed on the anode side of the electrolyte layer and sintered and a cathode layer screen printed on a cathode side of the electrolyte layer with cathode bond paste applied on the dried cathode layer and affixed with a metallic mesh, wherein the cathode paste is dried by oven heating.

Also disclosed herein is a SOFC including an electrolyte layer, an anode coupled to the electrolyte layer and a cathode coupled to the electrolyte layer, wherein the anode is prepared by applying an anode contact layer to the anode support side and applying anode bond paste to the anode contact layer, wherein the cathode is prepared by screen printing a cathode layer on the electrolyte, followed by applying cathode bond paste to the dried cathode layer and drying the cathode bond paste in an oven.

### BRIEF DESCRIPTION OF THE DRAWINGS

The disclosure and embodiments thereof will become apparent from the following description and the appended drawings, in which the like elements are numbered alike:

FIG. 1 illustrates a perspective view of a planar SOFC assembly manufactured in accordance with exemplary embodiments;

FIG. 2 illustrates a perspective exploded view of a single unit of a planar SOFC stack manufactured in accordance with exemplary embodiments;

FIG. 3A illustrates a flowchart of an exemplary SOFC cathode processing method;

FIG. 3B illustrates intermediate structures resulting from the steps as discussed in method;

FIG. 4 illustrates a plot of power density versus operation time of cells fabricated in accordance with exemplary embodiments;

FIG. 5 illustrates an initial microstructure of LSCF/GDC cathode fabricated in accordance with exemplary embodiments;

FIG. 6 illustrates the microstructure of LSCF/GDC cathode after 430 hours test in accordance with exemplary embodiments;

FIG. 7 illustrates the initial microstructure of LSCF/GDC cathode sintered at 1000° C.;

FIG. 8 illustrates a plot of porosity versus time, illustrating how the 800° C. in-situ processed cathode evolves to a high temperature processed structure over time.

### DETAILED DESCRIPTION OF EXEMPLARY EMBODIMENTS

Exemplary embodiments include an in-situ process to fabricate SOFC, thereby reducing high temperature sintering. Performance improvement of in-situ LSCF and gadolinium doped ceria (GDC) composite cathode is provided. For example, 800° C. in-situ processing eliminates the external cathode and bond paste sintering cycles and incorporates those steps into one step. The fuel cell is assembled and loaded in the test rig at temperature lower than 100° C. The cathode sintering, current collector bonding and anode reduction can be completed in the test rig in-situ from room temperature to SOFC operating temperature. For example, as described further below, on a one-inch button cell level, with in-situ LSCF/GDC cathode, power density of 1 W/cm² is obtained on sintered cells without performance degradation in continuous 430-hour tests.

Exemplary embodiments further include systems and methods for incorporating external cathode formation, cathode pre-bonding, and anode pre-bonding cycles into one step, which expedite the SOFC processing and reduce the cost. In exemplary implementations, high temperature (>1000° C.) cathode sintering processing is reduced to 800° C. in-situ, which simplifies the SOFC fabrication, lowers bond paste/ferritic steel interconnect interface contact resistance (i.e., interface of bond paste and cathode current collector), and therefore increases SOFC performance. Furthermore, non-noble metal (i.e., ferritic steel) interconnects can be implemented because the methods described herein lower SOFC processing temperature to 800° C.

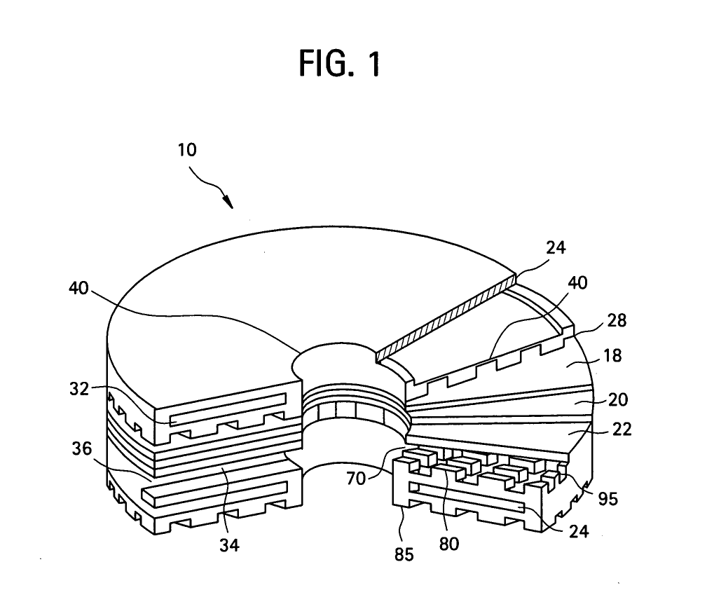

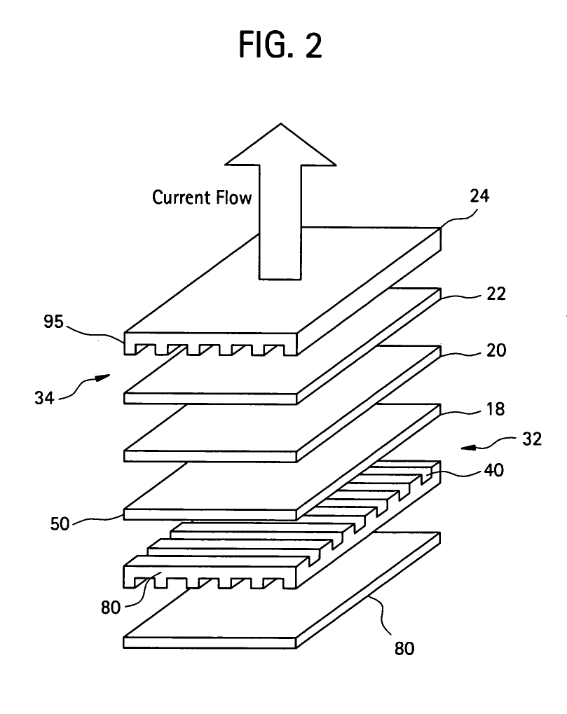

FIG. 1 illustrates a perspective view of a planar SOFC assembly 10 manufactured in accordance with exemplary embodiments. FIG. 2 illustrates a perspective exploded view of a single unit of a planar SOFC stack 50 manufactured in accordance with exemplary embodiments. SOFC assembly 10 is an array bundle or stack of fuel cells comprising at least one fuel cell 50. Each fuel cell 50 is a repeat cell unit 50 capable of being stacked together either in series or in parallel or both, to build fuel cell stack systems or architecture, capable of producing a resultant electrical energy output. Referring to FIG. 1 and FIG. 2, at least one fuel cell 50 includes an anode 22, a cathode 18, an electrolyte 20 interposed therebetween, an interconnect 24, which is in intimate contact with at least one of the anode 22, the cathode 18 and the electrolyte 20, at least one fluid flow channel 95 and at least one fiber 40 disposed within at least one fluid flow channel 95. The at least one fluid flow channel 95 typically includes at least one oxidant flow channel 28 and at least one fuel flow channel 36 disposed within the fuel cell 50. At least one fiber 40 is disposed within at least one of the oxidant flow channel 28 and the fuel flow channel 36. These fibers disrupt the oxidant flow, traveling through the oxidant flow channel 28, and the fuel flow, traveling through the fuel flow channel 36 respectively.

The oxidant 32, for example air, is fed to the cathode 18. Oxygen ions (O²⁻) generated at the cathode 18 are transported across the electrolyte 20 interposed between the anode 22 and the cathode 18. A fuel 34, for example natural gas, is fed to the anode. The fuel 34 at the anode site reacts with oxygen ions (O²⁻) transported to the anode 22 across the electrolyte 20. The oxygen ions (O²⁻) are de-ionized to release electrons to an external electric circuit 65. The electron flow thus produces direct current electricity across the external electric circuit 65. The electricity generation process produces certain exhaust gases and generates waste heat.

Anode 22 provides reaction sites for the electrochemical oxidation of a fuel gas introduced into the fuel cell. In addition, the anode material should be stable in the fuel-reducing environment, have adequate electronic conductivity, surface area and catalytic activity for the fuel gas reaction at the fuel cell operating conditions and have sufficient porosity to allow gas transport to the reaction sites. The materials suitable for anode 22 having these properties, include, but are not limited to metallic nickel, nickel alloy, silver, copper, noble metals such as gold and platinum, cobalt, ruthenium, nickel-yttria-stabilized zirconia cermets (Ni—YSZ cermets), copper-yttria-stabilized zirconia cermets (Cu—YSZ cermets), Ni-ceria cermets, other ceramics or combinations thereof.

Cathode 18 provides reaction sites for the electrochemical reduction of the oxidant. Accordingly, cathode 18 must be stable in the oxidizing environment, have sufficient electronic conductivity, surface area and catalytic activity for the oxidant gas reaction at the fuel cell operating conditions and have sufficient porosity to allow gas transport to the reaction sites. The materials suitable for cathode 18 having the aforesaid properties, include, but are not limited to lanthanum manganate (LaMnO₃), strontium-doped LaMnO₃ (SLM), tin doped Indium Oxide (In₂O₃), doped YmnO₃, CaMnO₃, YFeO₃, strontium-doped PrMnO₃, barium strontium cobalt iron oxide, strontium doped lanthanum ferrites, strontium doped lanthanum cobaltites, strontium doped lanthanum cobaltite ferrites, strontium ferrite, doped LaFeO₃—LaCoO₃, RuO₂-Yttria-stabilized zirconia (YSZ), lanthanum cobaltite, and combinations thereof.

Anode 22 and cathode 18 can have a surface area sufficient to support electrochemical reactions. The materials used for anode 22 and cathode 18, are thermally stable between the typical minimum and maximum operating temperature of the fuel cell assembly 10, for example between about 600 ° C. to about 1300 ° C.

The main purpose of electrolyte 20 disposed between anode 22 and cathode 18 is to transport oxygen ions (O²⁻) between cathode 18 and anode 22. In addition to the above, electrolyte 20 separates the fuel from the oxidant in the fuel cell 50. Accordingly, electrolyte 20 must be stable in both the reducing and oxidizing environments, impermeable to the reacting gases and adequately conductive at the operating conditions. The materials suitable for electrolyte 20 having the aforesaid properties, include, but are not limited to, zirconium oxide, yttria stabilized zirconia (YSZ), doped ceria, cerium oxide (CeO₂), bismuth sesquioxide, pyrochlore oxides, doped zirconates, perovskite oxide materials and combinations thereof.

The primary function of interconnect 24 is to electrically connect anode 22 of one repeatable cell unit to cathode 18 of an adjacent cell unit. In addition, interconnect 24 should provide uniform current distribution, should be impermeable to gases, stable in both reducing and oxidizing environments, and adequately conductive to support electron flow at a variety of temperatures. The materials suitable for interconnect 24 having the aforesaid properties, include, but are not limited to, noble metals, chromium based ferritic stainless steel, cobaltite, ceramic, lanthanum chromate (LaCrO₃), cobalt dichromate (CoCr₂O₄), Inconel 600, Inconel 601, Hastelloy X, Hastelloy-230, Ducrolloy, Kovar, Ebrite and combinations thereof.

As discussed above, currently implemented sintering cycles are eliminated in accordance with exemplary embodiments of the SOFC assembly 10 manufacturing process. As such, external sintering cycles for cathode, cathode bond layer with current collector and anode bond layer with current collector are eliminated. In addition, processing temperatures that are no higher than the fuel cell operating temperature (for example between about 600° C. to about 1300° C., as discussed above) are implemented during exemplary processing methods. High performance and long-term stability can be observed with the in-situ fabrication methods described herein. In general, higher performing cathode microstructures have low porosity (typically, cathode porosities are observed in the range of 20% to 50%, 20% is generally considered low). Preliminary modeling results suggested that the cathode with low porosity has lower overpotential loss compared with that with high porosity. Meanwhile good bonding between cathode and bond paste phases can be achieved by either heat treating the cells at higher temperatures or at lower temperatures for longer time. The microstructure in exemplary cathodes improves toward a lower porosity with time at the operating temperature (800° C. in this case) to improve its performance over time, which stabilizes the fuel cell performance with respect to degradation. Compared with the cathode sintered at higher temperatures with low porosity, the in-situ cathode starts with high porosity and evolves to low porosity during operation, which gains extra time in terms of performance degradation. Microstructure evolution of in-situ cathode is observed over 430-hour fuel cell performance tests. As such, microstructure evolution of in-situ cathodes demonstrates self-improvement of SOFC performance, which balances some degradation behavior.

The processing of SOFC assembly in accordance with exemplary embodiments is now discussed.

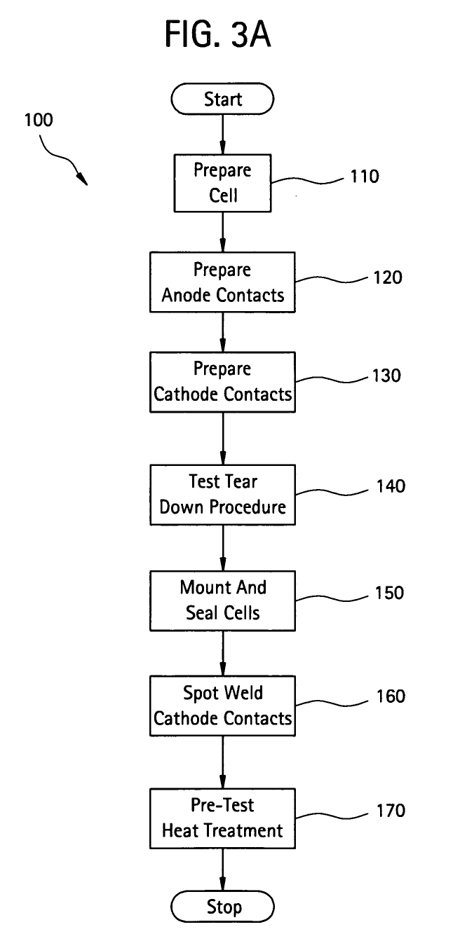

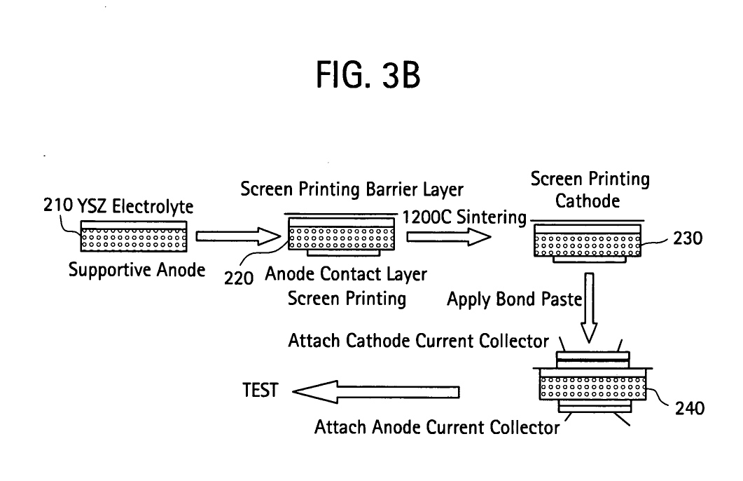

FIG. 3A illustrates a flowchart of an exemplary SOFC cathode processing method 100. FIG. 3B illustrates intermediate structures 200 resulting from the steps as discussed in method 100. At step 110, a button cell is prepared by screen printing a barrier layer on top of an YSZ layer, illustrated as intermediate structure 210. An anode contact layer is screen printed on the anode side of the button side, illustrated as intermediate structure 220, and the button cell is sintered. A cathode layer is screen printed on the cathode side of the button cell, illustrated as intermediate structure 230. At step 120, the anode contacts are prepared on the sintered anode side of the button cell by affixing a perforated support with an anode bond paste, and subsequently dried in an oven. At step 130 the cathode contacts are prepared on the cathode side of the button cell by affixing a mesh screen (e.g., gold) with a cathode bond paste illustrated as intermediate structure 240. At step 140, the test equipment is removed.

At step 150, the cell is mounted and sealed to six-gun tubes. In general, the gold mesh is bent up to expose as much of the electrolyte as possible. Cement is applied to the edge of the cell to fully seal the anode into the tube. Cement is encroached onto the cathode to minimize the exposed electrolyte without touching the cathode. At step 160, the cathode contacts are spot welded.

The following example illustrates SOFC assembly 10 manufactured in accordance with process 300. LSCF/GDC cathode 18 is applied to electrolyte 20 at room temperature. Suitable application methods include screen-printing, doctor-blading, and wet particle spraying. After the paste is dried in an oven at 70-80° C., bond paste and current collector are applied on top of cathode 18. The whole cell assembly 10 is completed without external air furnace sintering. The assembled cell is loaded to the test rig for performance test. The heat treatment required for cathode, bond paste and anode is completed in one step in the test rig, from room temperature to the operating temperature. Performance test started at operating temperature after the heat treatment is finished.

### EXAMPLE

### Cell Preparation

Sintered one-inch button cells to be tested are obtained. The button cells are cleaned in a supersonic bath for 15 min, using alcohol as a solvent. The alcohol is drained and the cells are rinse with de-ionized (DI) water in a supersonic bath for another 15 min. The cells are dried at 70-80° C. for a minimum of 1 h.

A ceria based barrier layer is screen-printed on top of YSZ layer and dried at 70-80° C. for a minimum of 1 h.

An anode contact layer is screen-printed on the anode side and dried at 70-80° C. for a minimum of 1 h.

The cells are then sintered in an air furnace at 1200° C. for 2 h with slow heating up and cooling down rate.

The cathode is screen-printed on top of the sintered barrier layer and dried at 70-80° C. for a minimum of 1 h.

The cells are then collected to apply cathode and anode contacts as described below. Care needs to be taken at this point not to touch the cathode surface to avoid contamination.

### Prepare Anode Contacts

A ferritic steel perforated support is used as the anode current collector. Two strips of Hastelloy-X ribbon are cut for each cell. The two strips are spot welded onto the perforated support.

The surface of the perforated support is polished without Hastelloy-X ribbons affixed on the surface in order to remove the oxidized layer. The polished perforated support is cleaned in a supersonic bath for 15 min, using alcohol as a solvent, followed by DI water for a rinse cycle of another 15 min. The perforated support is dried at 70-80° C. for 30 min.

A nickel oxide based anode bond paste is applied on top of the sintered anode contact layer. The polished surface of the perforated support is pushed against the bond paste to ensure good contact.

The cells are dried at 80±5° C.

### Prepare Cathode Contacts

A piece of 82-100 mesh Au screen is cut into 1″×¾″ pieces and flattened to be used as the cathode current collector.

Cathode bond paste is applied to the cathode and spread out using a paintbrush. The gold screen is placed onto the cell, centering as best as possible. The screen is pushed down so that it touches the surface of the cathode and the bond paste is spread evenly to cover the cathode.

The cells are dried at 75±5° C. Ceramic beads are placed on the screen and weighted suitably to ensure close contact of the mesh to the cathode once the paste has fully dried.

The weights and ceramic beads are removed from fully dried samples and bond paste is applied on top of the Au screen after the samples have cooled down to room temperature. The cells are again dried at 75±5° C. for a minimum of 2 h.

### Mount and Seal Cell to Tube

The Pt wires are spot welded in the tube to the Hastelloy contacts on the anode side.

A weight is placed on top of the cell to ensure that the cells sit flush with the edge of the testing tube.

A bead of high temperature cement is applied to cover the entire edge of the cell and the tube is left undisturbed for at least 1 hr.

Two to three more coatings of cement are applied around the edge of the cell and the tube to fully seal the cell into the tube. Leave it dry for at least 1 hour or until dry.

### Spot Weld Cathode Contacts

The weights are removed from the cathode side and the edges of Au screen are bent to a vertical position taking care not to de-bond from the cathode.

The Pt wires on the outside of the tube are spot welded to the edges of the Au screen. The resistance between the current and voltage connectors on both the anode and cathode side is measured to ensure good contact.

The air tubes are bent down so that the end of the tube is centered and close to the cathode.

### Pre-Test Heat Treatment

The testing assembly is placed into the furnace and aligned.

The furnace is closed and ready to heat up.

The furnace is heated up in air with a ramp rate of 1° C./min from room temperature to SOFC operation temperature, with dwelling periods at intermediate temperatures.

The furnace temperature is held at the operating temperature to commence the anode reduction process until the OCV reaches a stable value. If a fixed humidity (e.g. 3%) is required, a water bubbler can be connected to the flowing fuel.

### Performance Test

To test the performance of the cell fabricated under the exemplary process described, the fuel flow rate the fuel concentration can be set according to a customer's requirement. In general, the flow rate is 200 sccm, 64% humidified H₂.

The following table provides a guideline for establishing flow rates to simulate utilization.

TABLE 1
Gas Flow rates to simulate utilization

| | |
|---|---|
| Gas | Flow Rate (SLPM) |

| | | | | |
|---|---|---|---|---|
| Hydrogen | 0.8 | 0.45 | 0.15 | 0.23 |
| Nitrogen | 0.45 | 0.8 | 1.1 | 1.02 |
| Air | 5 | 5 | 5 | 5 |
| Simulated Utilization (%) | 64 | 36 | 18.4 | 12 |

The OCV of the cell can then be checked and recorded. A power curve can be taken while decreasing voltage from open circuit voltage (OCV) condition to about 0.55V.

The AC impedance under OCV conditions is measured. A test under either constant load or constant current can then be started.

As per the customer's requirement, the time of the performance test can vary from 50 h to 1000 h or more. Tests under different temperature, different fuel concentration and other different conditions can also be performed.

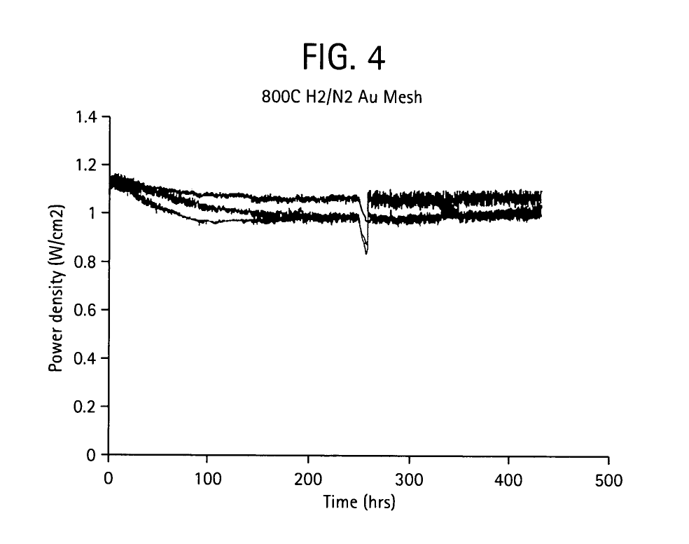

FIG. 4 illustrates a plot of power density versus time of a cell fabricated in accordance with exemplary embodiments. As discussed above, the cell fabricated in accordance with exemplary embodiments demonstrates high performance (1 W/cm2) of in-situ LSCF/GDC cathode. No degradation behavior is observed during the 430-hour test.

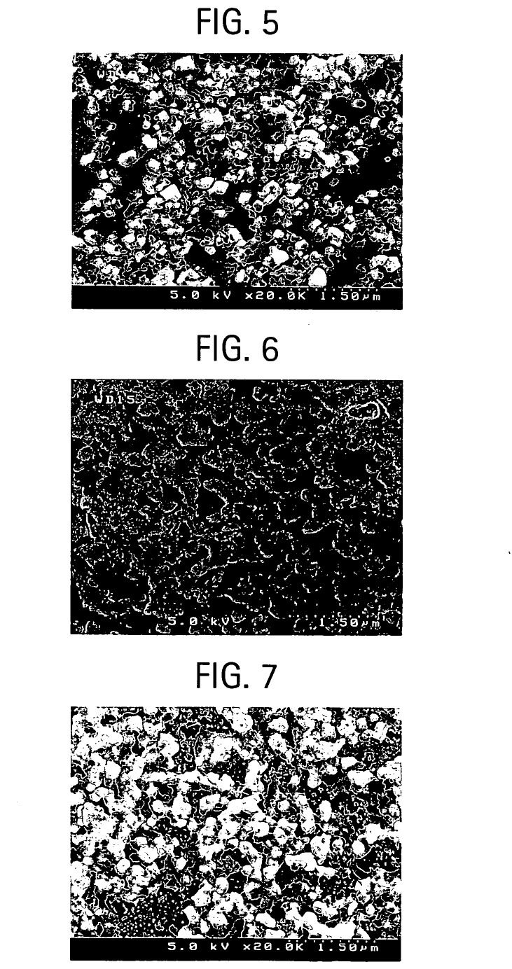

FIG. 5 illustrates an initial microstructure of a SOFC fabricated in accordance with exemplary embodiments. The SOFC showed the initial microstructure of the in-situ LSCF/GDC cathode, average particle size 110 nm, porosity 57%.

FIG. 6 illustrates the microstructure of LSCF/GDC cathode after 430 hours test, average particle size 205 nm, porosity 44% in accordance with exemplary embodiments.

FIG. 7 illustrates the initial microstructure of LSCF/GDC cathode sintered at 1000° C., average particle size 201 nm, porosity 45%. It is clear the in-situ cathode microstructure evolves to a higher temperature sintered one during test at 800° C. This result indicates the fact that in-situ cathode benefits the cell performance in terms of degradation.

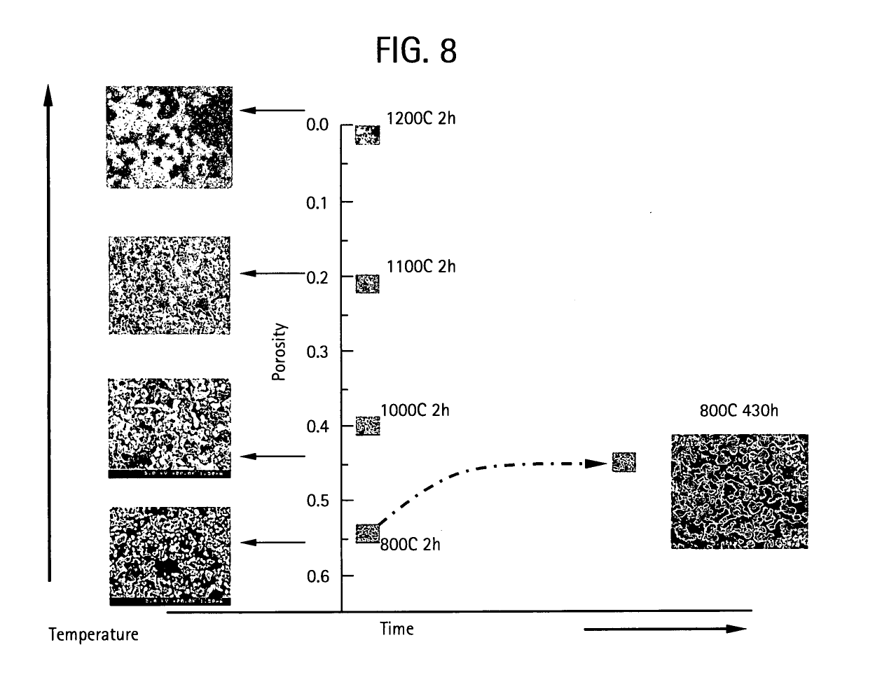

FIG. 8 illustrates a plot of porosity versus time, illustrating how the 800° C. in-situ processed cathode evolves to a high temperature processed structure over time.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A solid oxide fuel cell (SOFC) fabrication method, comprising
preparing a SOFC button cell;
preparing anode contacts;
preparing both cathode and cathode contacts in-situ (fabrication temperature does not exceed the SOFC operation temperature); and
attaching cathode and anode current collectors.

2. The method as claimed in claim 1 wherein preparing the SOFC button cell comprises:
screen printing a barrier layer on a yttria-stabilized zirconia (YSZ) layer; and
screen printing an anode contact layer on an anode side of the button cell.

3. The method as claimed in claim 2 further comprising sintering the barrier layer and anode contact layer on the button cell.

4. The method as claimed in claim 3 wherein preparing the anode contacts comprises preparing a perforated support.

5. The method as claimed in claim 4 wherein preparing the anode contacts further comprises:
applying anode bond paste to the sintered anode contact layer; and
applying the perforated support to the applied bond paste.

6. The method as claimed in claim 1 wherein preparing the cathode layer and the cathode contacts comprises applying cathode bond paste to a cathode side of the button cell.

7. The method as claimed in claim 6 wherein preparing the cathode contacts further comprises drying the cathode bond paste at a temperature below 200° C.

8. The method as claimed in claim 7 wherein preparing the cathode contacts further comprises applying an interconnect material to the applied cathode paste.

9. The method as claimed in claim 8 further comprising connecting cathode voltage and current contacts to the interconnect material.

10. The method as claimed in claim 9 wherein connecting cathode voltage and current contacts to the interconnect material comprises spot welding.

11. The method as claimed in claim 1 further comprising operating the SOFC at operating temperatures thereby enabling cathode microstructure evolution.

12. The method as claimed in claim 11 wherein cathode microstructure evolution comprises decreased cathode porosity as a function of operating temperature and time.

13. The method as claimed in claim 12 wherein the cathode porosity changes from an initial range of 55 to 60%, to a range of 40 to 45% during the first 500 hrs of operation.

14. The method as claimed in claim 11 wherein cathode microstructure evolution comprises increased necking of cathode particles.

15. The method as claimed in claim 11 wherein the bonding improves between the functional layers as a function of operating temperature and time.

16. A solid oxide fuel cell (SOFC), comprising:
an electrolyte layer;
an anode layer with an interconnect attached; and
a cathode layer with an interconnect.

17. The SOFC as claimed in claim 15 further comprising a cathode and anode side interconnects attached to voltage and current leads.

18. The SOFC as claimed in claim 16 wherein the cathode comprises a microstructure defined by a porosity that decreases as a function of operating temperature and time.

19. The SOFC as claimed in claim 17 wherein the cathode comprises a microstructure defined by necking of the cathode particles that increases as a function of operating temperature and time.

20. The SOFC as claimed in claim 17 wherein the bonding improves between the functional layers as a function of operating temperature and time.

21. The SOFC as claimed in claim 16 wherein the cathode comprises a microstructure that evolves to a decreased porosity and an increased necking and bonding after operation of a temperature of 800° C. and greater than 100 hours.

22. A solid oxide fuel cell (SOFC), comprising:
an electrolyte layer;
an anode coupled to the electrolyte layer; and
a cathode coupled to the electrolyte layer,
wherein the anode is prepared by applying an anode contact layer to the supportive anode and applying anode bond paste to the anode contact layer and sintering the combination,
wherein the cathode is prepared by applying a cathode layer on the electrolyte with or without a barrier layer, and applying cathode bond paste to the dried cathode layer and drying the cathode bond paste in an oven.

23. The SOFC as claimed in claim 21 wherein the cathode is further prepared by operating the SOFC at SOFC operating temperatures, thereby decreasing porosity and increasing connectivity of the cathode during operation.
